(19) United States
(12) Patent Application Publication
(10) Pub. No.: US 2025/0278726 A1
(43) Pub. Date: Sep. 4, 2025

(54) SYSTEMS AND METHODS FOR EXECUTING AN AUTHENTICATION MODULE

(71) Applicant: The Toronto-Dominion Bank, Toronto (CA)

(72) Inventors: Shishir Dattatraya BHAT, Toronto (CA); Robert Dean ALLEN, London (CA); Edward SPENCER, Richmond Hill (CA); Jason John MAILLOUX, London (CA)

(73) Assignee: The Toronto-Dominion Bank, Toronto, ON (CA)

(21) Appl. No.: 18/594,316

(22) Filed: Mar. 4, 2024

(51) Int. Cl. G06Q 20/40

(52) U.S. Cl. CPC G06Q 20/401

(57) ABSTRACT

Methods and computer systems for executing an authentication module. Receiving a first request from a first system executing a first software application. In response to receiving the first request, execute an authentication module. Receiving a second request from a second system executing a second software application. In response to receiving the second request, execute the authentication module, wherein executing the authentication module configures the authentication module to authenticate a credential received from the second system as being associated with a particular profile; identify one or more accounts to be used in fulfilling an associated request, the one or more accounts corresponding to the particular profile; and obtain an indication of consent to perform an operation associated with the associated request.

### FIELD

The present disclosure relates to authentication and, more particularly, to systems and methods for executing an authentication module.

### BACKGROUND

Authentication is commonly used to prohibit unauthorized access of data.

In some scenarios, users may wish to grant permission to third-party software applications to access their data. For example, a user may provide, to a third-party application, their login credentials (i.e. username and password) for accessing their account, and the third-party application may use those login credentials to retrieve account data. Upon successful authentication, the access control system allows the requesting third-party application to gain access to the user's account.

It would be advantageous to provide for enhanced efficiency and usability of authentication frameworks.

### BRIEF DESCRIPTION OF THE DRAWINGS

Reference will now be made, by way of example, to the accompanying drawings which show example embodiments of the present application, and in which:

FIG. 1 shows a schematic diagram illustrating an operating environment of an example embodiment according to the subject matter of the present application;

FIG. 2 shows a high-level schematic diagram of the client device, authentication system and third-party systems of FIG. 1;

FIG. 3 shows a simplified organization of software components stored in a memory of the example computing systems of FIG. 2;

FIG. 4 shows, in flowchart form, a method of executing an authentication module, according to an example embodiment;

FIG. 5 shows, in flowchart form, an example method of executing an authentication module, according to another example embodiment;

FIG. 6 shows, in flowchart form, an example method of executing an authentication module, according to yet another example embodiment;

FIG. 7 is an example third-party graphical input interface for initiating a data access request;

FIG. 8 is an example first-party graphical input interface for authenticating a user of a client device;

FIG. 9 is an example first-party graphical input interface for accepting data sharing terms and conditions;

FIG. 10 is an example first-party graphical input interface for identifying one or more accounts associated with a profile corresponding to a user of a client device;

FIG. 11 is an example first-party graphical input interface for providing authorization to access to data;

FIG. 12 is an example first-party graphical input interface for indicating successful authorization to access to data;

FIG. 13 is an example third-party graphical input interface for indicating successful authorization to access to data; and

FIG. 14 is an example first-party graphical input interface for managing data sharing and access permissions.

Similar reference numerals may have been used in different figures to denote similar components.

### DETAILED DESCRIPTION OF EXAMPLE EMBODIMENTS

In one embodiment, the present application describes a computer system. The computer system may include a communications module; one or more processors coupled to the communications module; and a memory coupled to the one or more processors. The memory may store instructions that, when executed by the computer system, cause the computer system to receive a first request from a first system executing a first software application, the first request triggered by the first software application and representing a data sharing request; in response to receiving the first request, execute an authentication module; receive a second request from a second system executing a second software application, the second request triggered by the second software application and representing a request for configuring a payment in an e-commerce checkout; and in response to receiving the second request, execute the authentication module, wherein executing the authentication module configures the authentication module to: authenticate a credential received from the second system as being associated with a particular profile; identify one or more accounts to be used in fulfilling an associated request, the one or more accounts corresponding to the particular profile; and obtain an indication of consent to perform an operation associated with the associated request.

In some implementations, the first and second software applications may be third-party applications, the authentication module may be included in a web application that is separate from the first and second software applications, and the first and second systems may be client devices.

In some implementations, the request for configuring the payment in the e-commerce checkout may be a pay-by-bank request and the one or more accounts may be one or more bank accounts.

In some implementations, the instructions may cause the computer system to receive the second request triggered by the second software application and execute the authentication module in response to receiving the second request during an authenticated session associated with the second software application.

In some implementations, the second request may include an identifier associated with the second software application.

In some implementations, the instructions that, when executed by the computer system, cause the computer system to execute the authentication module in response to receiving the second request may include instructions that further cause the computer system to map the identifier to data to be used in one or more graphical elements of a graphical interface.

In some implementations, the instructions that, when executed by the computer system, cause the computer system to execute the authentication module in response to receiving the first request may include instructions that further cause the computer system to configure a first instance of the graphical interface to include one or more interface elements associated with the first software application.

In some implementations, the instructions that, when executed by the computer system, cause the computer system to execute the authentication module in response to receiving the second request may include instructions that further cause the computer system to configure a second instance of the graphical interface to include one or more interface elements associated with the second software application instead of the one or more interface elements associated with the first software application.

In some implementations, the one or more interface elements associated with the first software application may include a representation of branding associated with the first software application.

In some implementations, the instructions that, when executed by the computer system, may further cause the computer system to provide a historical list defining entities corresponding to a plurality of software applications, including the first and second software applications, that have engaged the authentication module.

In another aspect, the present application describes a computer-implemented method. The computer-implemented method may include receiving a first request from a first system executing a first software application, the first request triggered by the first software application and representing a data sharing request; in response to receiving the first request, executing an authentication module; receiving a second request from a second system executing a second software application, the second request triggered by the second software application and representing a request for configuring a payment in an e-commerce checkout; and in response to receiving the second request, execute the authentication module, wherein executing the authentication module configures the authentication module to: authenticate a credential received from the second system as being associated with a particular profile; identify one or more accounts to be used in fulfilling an associated request, the one or more accounts corresponding to the particular profile; and obtain an indication of consent to perform an operation associated with the associated request.

In some implementations, receiving the second request triggered by the second software application and executing the authentication module in response to receiving the second request may occur during an authenticated session associated with the second software application.

In some implementations, executing the authentication module in response to receiving the second request may include mapping the identifier to data to be used in one or more graphical elements of a graphical interface.

In some implementations, executing the authentication module in response to receiving the first request may include configuring a first instance of the graphical interface to include one or more interface elements associated with the first software application.

In some implementations, executing the authentication module in response to receiving the second request may include configuring a second instance of the graphical interface to include one or more interface elements associated with the second software application instead of the one or more interface elements associated with the first software application.

In some implementations, the method may further include providing a historical list defining entities corresponding to a plurality of software applications, including the first and second software applications, that have engaged the authentication module.

In yet another aspect, present application describes a non-transitory computer-readable storage medium comprising processor-executable instructions which, when executed, may configure one or more processors to receive a first request from a first system executing a first software application, the first request triggered by the first software application and representing a data sharing request; in response to receiving the first request, execute an authentication module; receive a second request from a second system executing a second software application, the second request triggered by the second software application and representing a request for configuring a payment in an e-commerce checkout; and in response to receiving the second request, executing the authentication module, wherein executing the authentication module configures the authentication module to: authenticate a credential received from the second system as being associated with a particular profile; identify one or more accounts to be used in fulfilling an associated request, the one or more accounts corresponding to the particular profile; and obtain an indication of consent to perform an operation associated with the associated request.

In yet a further aspect, the present application describes a non-transitory computer-readable storage medium storing processor-readable instructions that, when executed, configure one or more processors to perform any of the methods described herein. Also described in the present application is a computing device comprising: one or more processors, memory, and an application containing processor-executable instructions that, when executed, cause the one or more processors to carry out at least one of the methods described herein. In this respect, the term processor is intended to include all types of processing circuits or chips capable of executing program instructions.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

The term “real-time”, “near real-time”, or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 millisecond, less than 1 second, or less than 5 seconds.

Example embodiments of the present application are not limited to any particular operating system, system architecture, mobile device architecture, server architecture, or computer programming language.

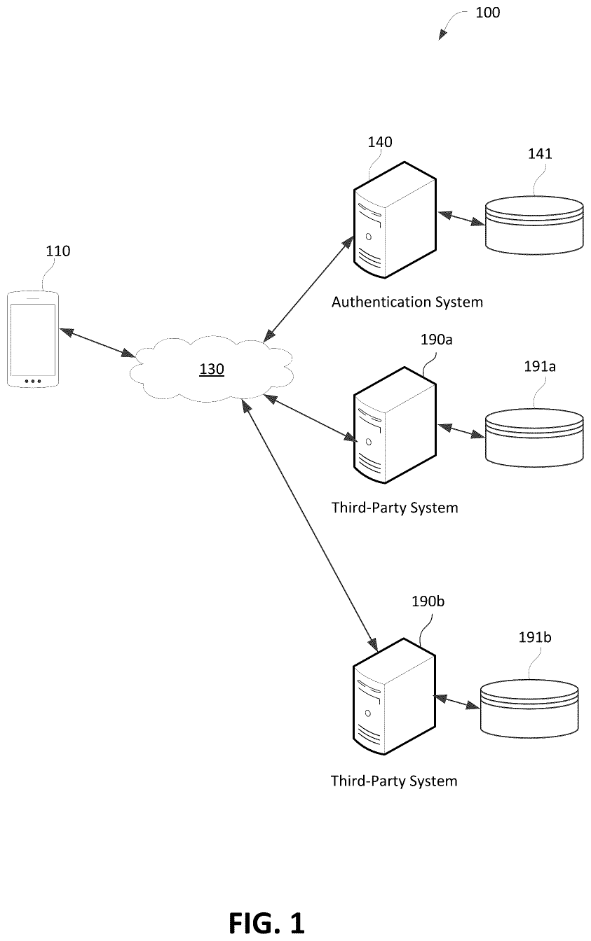

FIG. 1 shows a schematic diagram illustrating an operating environment of an example embodiment. The various components cooperate to provide a computing system 100 which may be used, for example, to share data between computer systems. Examples of data that may be shared include profile, user, account, payment, transactional, and/or resource information. Resources may include physical assets, credits, tokenized items like non-fungible tokens, computing resources such as memory allocated or processor time, access rights, or any other resource that may be owned or credited to an account associated with an account holder. In many of the examples herein, monetary resources may be referenced to illustrate concepts, but the present application is not necessarily solely applicable to financial or monetary instruments or resources. In some embodiments, an account that holds or stores resources for transfer to and/or from the account is sometimes referred to as a resource account, financial account or debit account that allows a customer to withdraw money or make purchases using funds or resources that have been deposited into the account.

The operating environment in this example includes a client device 110, an authentication system 140, and third-party systems 190. In some embodiments, the operating environment may include one or more client devices or a plurality of client devices, which may include the client device 110. The operating environment may also include one or more systems, which may include the third-party systems 190, that are external to the authentication system 140.

The client device 110 may be associated with an entity, such as a user of the client device. The entity may have a one or more profiles and/or accounts that may be stored in one or more of the data stores 141, 191a and/or 191b associated with, provided by and/or corresponding to the authentication system 140 and/or third-party systems 190. Each profile may also include a record that may be or represent account data or other data maintained by the associated system. The record may include data of various types and the nature of the data will depend on the nature of the associated system. By way of example, in some implementations, the record may include, for example, documents and/or other data stored by or on behalf of a user. Such documents and/or data may include, for example, any one or more of: digital identity data such as stored identity information or documentation, transactional information, photographs, text-based documents, documents prepared according to a standardized file format, such as portable document format (PDF) documents, user preferences, or other types of documents and/or data. The transactional information may include historical data transfers for the account.

The authentication system 140 and/or third-party systems 190 may be configured to authenticate credentials received from the client device 110 as being associated with one or more profiles, accounts and/or authentication data maintained by the particular system performing the authentication. The authentication data may be or include one or more credentials such as, for example, a password, username, PIN, shared secret, and/or biometric data such as a fingerprint, voiceprint and/or facial profile data. Authentication may be performed based on one or more credentials.

In some embodiments, the authentication system 140 and/or third-party systems 190 may provide one or more front-end interfaces that allow the client device 110 to interact with the authentication system 140 and/or third-party systems 190. For example, the authentication system 140 may provide one or more graphical user interfaces (GUIs) to the client device 110.

The authentication system 140 and third-party systems 190 may be managed, operated, and/or controlled by respective entities that are independent from one another. An entity may be an agent of an account holder, which may be a user of the client device 110. The account holder may also be a customer (e.g. a corporate/business customer) or client of the entity or otherwise associated with the entity.

The authentication system 140 may handle authentication flows to connect the authentication system 140 to the third-party systems 190.

The authentication system 140 may store data regarding one or more third-party systems 190. In some embodiments, the data may represent a list of third-party systems 190. In some embodiments, the authentication system 140 may further include a hub that stores authorization to access data in the authentication system 140 and stores tokens to be used by the third-party systems 190 to access data on the authentication system 140. In some embodiments, the hub may be referred to as a data hub or open banking customer hub.

The third-party systems 190 may access data from the authentication system 140. Access to data from the authentication system 140 may be based on an access token. In some embodiments, the authentication system 140 may be referred to as an open banking provider system or open banking data provider system, the third-party systems 190 may be open banking data receiving systems, and/or the entity may be referred to as an open banking provider.

In some implementations, the third-party systems 190 may not obtain data from the authentication system 140 directly. Instead, in some implementations, data may be obtained via another system, which may be referred to as a data access platform (not shown). The data access platform may act as a third-party provider (TPP) system which accesses data from a data provider system and the third-party systems 190 may act as agent systems that receive data from the authentication system 140 via the data access platform. Use of the data access platform may allow for efficiencies since the data access platform may integrate with numerous data provider systems. By using the data access platform, the third-party systems 190 do not need to be configured to integrate with such numerous data provider systems. Instead, the third-party systems 190 may rely upon the data access platform for such functions and the data access platform may provide data access services to numerous computing systems to allow such systems to obtain data from numerous data provider systems.

The third-party systems 190 may be managed, operated, and/or controlled by third parties that are independent of the entity that manage, operate and/or control the authentication system 140. In some embodiments, one or more of the third-party systems 190 may be managed, operated, and/or controlled by an entity that may be an agent of an account holder and may be a financial institution, such as a bank. In many of the examples herein, financial institutions may be referenced to illustrate concepts, but the present application is not necessarily solely applicable to financial institutions.

The authentication system 140 and third-party systems 190 may be or include transfer processing systems. A transfer processing system may include a transfer processing module implemented as a software module and configured to process transfers such as transfers identified in transfer messages. By way of example, a processing module or system included in the authentication system 140 may be configured to perform internal transfers by transferring value between two different records in the data store 141 (i.e., between two accounts at the same financial institution) and/or to perform external transfers by interacting with one or more third-party systems 190. For example, external transfers may be performed using various transfer methods or protocols. In some implementations, at least some transfers may be performed by interacting with other financial institution systems via a SWIFT (Society for Worldwide Interbank Financial Telecommunication) network.

The authentication system 140 may include an authentication module implemented as a software module and configured to authenticate users of the authentication system 140 and manage data sharing and access permissions for resource accounts included in the authentication system 140. The authentication module may interact with a plurality of different software applications and third-party systems. The authentication module may provide common functionality utilized by a plurality of separate third-party software applications, which may be of distinct types.

As illustrated, the authentication system 140 is in communication with the third-party systems 190 via the network 130. The third-party systems 190 may be configured to transmit to the authentication system 140 a message, for example, a transfer message. The authentication system 140 may be further configured to receive a transfer message from the third-party systems 190. The authentication system 140 may also be configured to transmit to one or more third-party systems 190 a message, for example, a request for data. The third-party systems 190 may be further configured to receive a data request from the authentication system 140. The authentication system 140 may also be configured to transmit to the client device 110 a message, for example, regarding data. The terminal 120 may be further configured to receive data from the authentication system 140, for example, that is obtained from a third-party system 190.

The client device 110, authentication system 140, and third-party systems 190 may be configured to ingest data from each other and may transmit requests, replies, alerts, notifications, configuration objects, or other data to each other. The third-party systems 190 may employ a data service provided by one or more external sources. The external source of the data service may be the authentication system 140. The authentication system 140 may provide services used by the third-party systems 190. The authentication system 140 and third-party systems 190 may further store data in respective data stores 141, 191a and 191b. The data stores 141, 191a and 191b are illustrated as single units for ease of illustration, but may include a plurality of storage units and, in some cases, storage media connected via the network 130.

The services provided by the authentication system 140 may be incorporated into the services provided by the third-party systems 190, such that when the client device 110 submits a particular request to the third-party systems 190, such as clicking a particular link or button on a webpage, the third-party systems 190 execute an application programming interface (API) call to the authentication system 140. The authentication system 140 may then provide its service to the client device 110 through the webpages of the third-party systems 190.

The authentication system 140 and third-party systems 190 may include one or more webpages, or links or other actionable portion of webpages, that when selected execute an application programming interface call to a data service. The third-party systems 190 may receive data from the authentication system 140. The data may include any data relevant to providing the particular service, such as input data from the client device 110 that is previously stored by the authentication system 140 or data regarding interactions with the client device 110 during a session with the authentication system 140.

As illustrated, the client device 110 is in communication with an authentication system 140 via a network 130. In some embodiments, the client device 110 may be managed, operated or controlled by a holder of accounts with the authentication system 140 and/or third-party systems 190.

The client device 110 is a computing device and may be configured to receive input. It may, as illustrated, be a smart phone. However, the client device 110 may be a computing device of another type such as, for example, a mobile device, a desktop computer, a laptop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The client device 110 may be used, for example, to receive user input that includes an indication of an activation of a link. The user input may further include an indication of one or more parameters associated with a request. The one or more parameters may include login information and other information to be included in or used to populate one or more parameters in a request.

The authentication system 140 and third-party systems 190 are or include a computer system such as a computer server system, database management system, resource management systems, or data transfer systems. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, web servers, email servers, file transfer protocol (FTP) servers, compute servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The client device 110, authentication system 140, and third-party systems 190 may be in geographically disparate locations.

The network 130 is a computer network. The network 130 may be an internetwork such as may be formed of one or more interconnected computer networks. For example, such a network may be or may include an Ethernet network, an asynchronous transfer mode (ATM) network, a wireless network, or the like. In some implementations, the network 130 may be the Internet. The network 130 allows the client device 110, authentication system 140 and third-party systems 190 to communicate with one another.

As further described below, the client device 110, authentication system 140 and third-party systems 190 may be configured with software to perform associated functions such as those described herein.

FIG. 1 illustrates the authentication system 140, third-party systems 190 and data stores 141, 191a and 191b as separate and distinct computing devices. However, these systems may not all be separate physical systems. For example, the authentication system 140 and the data store 141 may be implemented on a common physical device. As another example, the third-party system 190a and the data store 191a may be implemented on a common physical device. As another example, the third-party systems 190 may be implemented on a common physical device and/or may be implemented in software associated with a common processor.

The third-party systems 190 may execute, at least in part, or in whole or in part, respective third-party software applications that are separate from the authentication system 140 and external to the authentication module included in the authentication system 140. The software third-party applications may be authorized by the authentication module to access data from one or more accounts included in the authentication system 140.

The client device 110 may be configured to execute one or more software applications. A software application may be executed, in whole or in part, or at least in part, by the client device 110 and may be provided to the client device 110 via a third-party server. For example, an application may be provided to the client device 110 by the third-party system 190a as a web-based or cloud-based application. The client device 110 may execute a client-side portion of the web-based or cloud-based application within a browser application (e.g. such that a storefront of an e-commerce store may be provided to the user via the browser). An application may be an interactive application in which a user may interact with the application, for example, via an input interface. An application may be a non-browser application, which may be a term that may refer to a software application or program that is not a web browser. An application may be a client application used to access or interact with online services or resources. A client application may include email applications, messaging apps, file transfer programs, remote desktop software, and many other types of applications that connect to the internet to access specific services or data. A client application may run external to a web browser.

It will be appreciated that the computing system 100 of FIG. 1 may be varied. Persons ordinarily skilled in the art will appreciate that in some embodiments one or more of the third-party systems 190 may instead be first-party systems or non-independent systems. In this case, the first-party systems and the authentication system 140 may be managed, operated, and/or controlled by a same entity that may be an agent of an account holder and may be a financial institution, such as a bank.

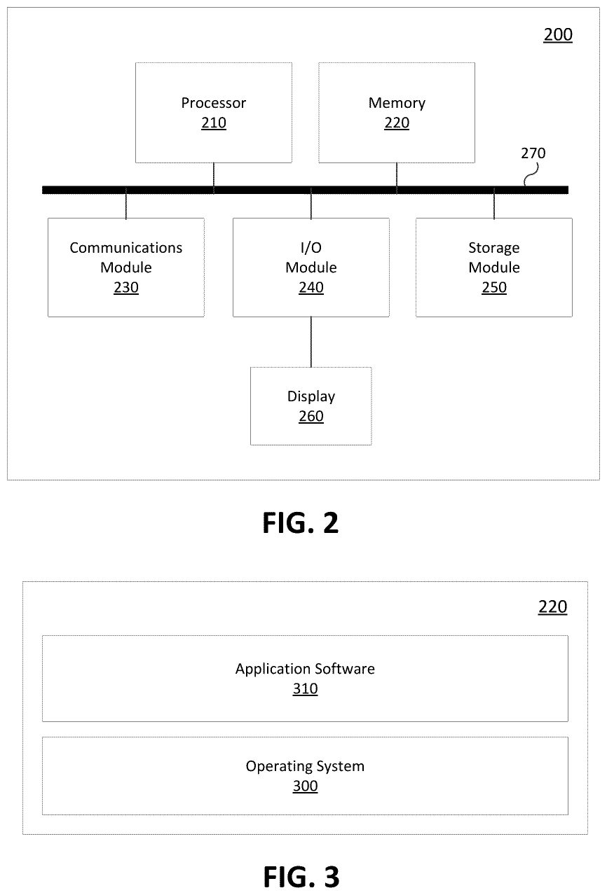

As noted above, the client device 110, authentication system 140 and third-party systems 190 are or include a computer system. An example computer system 200 will now be discussed with reference to FIGS. 2 and 3. Suitably-configured instances of the example computer system 200 may, in some embodiments, serve as and/or be a part of the client device 110, authentication system 140 and third-party systems 190.

FIG. 2 is a high-level schematic diagram of an example computer system 200.

The example computer system 200 includes a variety of modules. For example, as illustrated, the example computing system 200 may include a processor 210, a memory 220, a communications module 230, an I/O module 240, and/or a storage module 250. As illustrated, the foregoing example modules of the example computing system 200 are in communication over a bus 270. As such, the bus 270 may be considered to couple the various modules of the client device 110 to each other, including, for example, to the processor 210.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer system 200.

The communications module 230 allows the example computer system 200 to communicate with other computing devices and/or various communications networks such as, for example, the network 130. For example, the communications module 230 may allow the example computer system 200 to send or receive communications signals. Communications signals may be sent or received according to one or more protocols or according to one or more standards. The communications module 230 may allow the example computer system 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G or the like. Additionally or alternatively, the communications module 230 may allow the example computer system 200 to communicate using near-field communication (NFC), via Wi-Fi™, using Bluetooth™ or via some combination of one or more networks or protocols. In some embodiments, all or a portion of the communications module 230 may be integrated into a component of the example computer system 200. For example, the communications module 230 may be integrated into a communications chipset.

The I/O module 240 is an input/output module. The I/O module 240 allows the client device 110 to receive input from and/or to provide input to components of the example computer system 200 such as, for example, various input modules and output modules. For example, the I/O module 240 may, as shown, allow the example computer system 200 to receive input from and/or provide output to the display 260.

The storage module 250 allows the example computer system 200 to store and retrieve data and, in some embodiments, may be referred to as a data store or data facility. In some embodiments, the storage module 250 may be formed as a part of the memory 220 and/or may be used to access all or a portion of the memory 220. Additionally or alternatively, the storage module 250 may be used to store and retrieve data from persisted storage other than the persisted storage (if any) accessible via the memory 220. In some embodiments, the storage module 250 may be used to store and retrieve data in/from a database. A database may be stored in persisted storage. Additionally or alternatively, the storage module 250 may access data stored remotely such as, for example, as may be accessed using a local area network (LAN), wide area network (WAN), personal area network (PAN), and/or a storage area network (SAN). In some embodiments, the storage module 250 may access data stored remotely using the communications module 230. In some embodiments, the storage module 250 may be omitted and its function may be performed by the memory 220 and/or by the processor 210 in concert with the communications module 230 such as, for example, if data is stored remotely. The storage module 250 is illustrated as a single unit for ease of illustration, but may include a plurality of storage units.

The storage module 250 may have one or more logical storage areas. A logical storage area may include a record that may be or represent account data or other data maintained by the computer system 200. In some embodiments, the term account or user account may be used interchangeably with “logical storage area” or “record” or “record in a database.” A record may include data of various types and the nature of the data will depend on the nature of the computer system 200. By way of example, in some implementations, the record may include, for example, documents and/or other data stored by or on behalf of a user. Such documents and/or data may include, for example, any one or more of: digital identity data such as stored identity information or documentation, transactional information, photographs, text-based documents, documents prepared according to a standardized file format, such as portable document format (PDF) documents, user preferences, or other types of documents and/or data. The transactional information may include historical data transfers for the account.

The storage module 250 may store data regarding a plurality of profile objects that represent a plurality of profiles. A profile object may be a data structure and may include details regarding an entity, such as a user, associated with the computer system 200. Example details include a unique profile or user account identifier (ID), identification information (e.g., full name), contact information (e.g., phone number, email address, street address), sign in credentials (e.g., user name and password), and preferences. Profile details may be referred to as profile data.

The example computer system 200 may include or be connected to a display 260. The display 260 is a module of the example computer system 200. The display 260 is for presenting graphics. The display 260 may be, for example, a liquid crystal display (LCD). In addition to being an output device, the display 260 may also be an input device. For example, the display 260 may allow touch input to be provided to the example computer system 200. In other words, the display 260 may be a touch sensitive display module. In a particular example, the display 260 may be a capacitive touch screen.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the example computer system 200. As illustrated, these software components include an operating system 300 and an application software 310.

The operating system 300 is software. The operating system 300 allows the application software 310 to access the processor 210, the memory 220, the communications module 230, the I/O module 240, and the storage module 250 of the example computer system 200. The operating system 300 may be, for example, Google™ Android™, Apple™ iOS™, UNIX™, Linux™, Microsoft™ Windows™, Apple OSX™ or the like.

The application software 310, when executed, co-operates with the operating system 300 to adapt the example computer system 200 for some purpose and to provide some defined functionality. For example, the application software 310 may cooperate with the operating system 300 to adapt a suitable embodiment of the example computer system 200 to serve as the client of another embodiment of the example computer system 200.

The application software 310 may include or use one or more interfaces, such as an application programming interfaces (APIs). The interface may be configured to receive, process and send request messages between systems such as those in the computing system 100 of FIG. 1.

An application programming interface may be used to access data stored on the one or more external computer systems or to provide access to data stored on the computer system 200. The application programming interface may be provided by an operator of the computer system 200.

In some embodiments, an external computer system may provide an application programming interface. The application programming interface may be capable of downloading data from the other computer system. The computer system may receive data by using the application programming interface capable of downloading data from another computer system. In some embodiments, the computer system stores data associated with the application programming interface, such as a system identifier for the other computer system. The computer system may use the system identifier in conjunction with the application programming interface to connect with the other computer system. In some cases, the system identifier may include a domain name corresponding to the other computer system.

In some embodiments, the computer system uses the application programming interface to query the other system to retrieve data. For example, the data may include information associated with the user and stored by the other computer system. In some embodiments, the application programming interface may utilize a particular messaging protocol (e.g., a Representation State Transfer (REST) API (RESTful API) or a Simple Object Access Protocol (SOAP) API). Using the application programming interface may include generating a message in conformity with the particular messaging protocol for invoking the application programming interface.

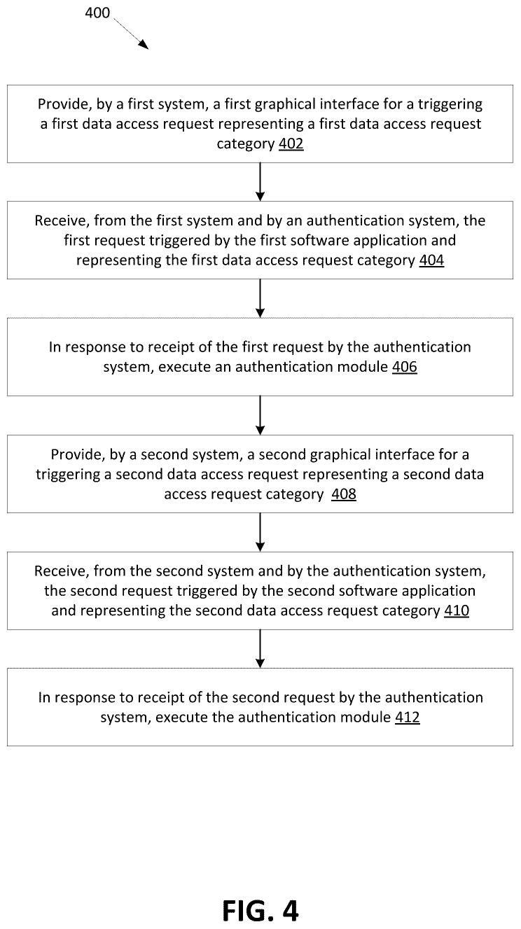

Reference will now be made to FIG. 4 which illustrates an example method 400 for sharing data between computing systems. The method 400 may be implemented by one or more computer systems suitably programmed to carry out the functions described. The operations of the example method 400 may be performed by one or more computer systems which may be of the type described herein. In some embodiments, the operations may be performed by the client device 110 and authentication system 140 of FIG. 1.

The computing system performing the method 400 may cooperate with other computing systems using a communications module. The communications module may be or include a hardware communications module. By way of example, the authentication system 140 may communicate with one or more of a client device 110 and third-party system 190 in order to perform the method 400 or a variation thereof.

In operation 402, a client device displays an interactive graphical interface for initiating a data access request. The interface is provided by and corresponds to a first software application associated with the client device.

The first software application may be executed, in whole or in part, on the client device. In some embodiments, the first software application is a client application that is installed and running on the client device. In some embodiments, the first software application is a web application where the client device executes the client side of the web application and a third-party system executes the server side of the web application.

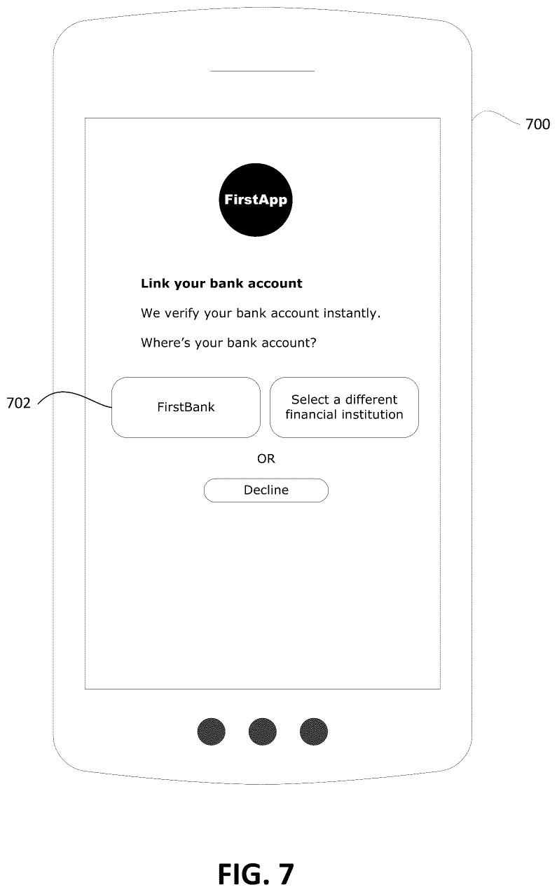

Referring briefly to FIG. 7, an example interface 700 is illustrated. In some embodiments, the interface 700 may be displayed at the client device in a web browser upon authentication of the user of the client device with a third-party system. The interface prompts for selection of a financial institution and includes a selectable element 702 that may be actuated to trigger the web browser to transmit to the authentication system user input indicating a data access request.

The interface 700 may be actionable, such as through the selectable element 702 included in the interface 700, which may be activated to actuated a user selection and to either directly or indirectly navigate to a website, webpage, application interface, or other user interface included in an authentication module.

In some embodiments, activation of the selectable option may activate a link that corresponds to the request and a web address. The web address may be an address associated with a web server that is provided by or is associated with the authentication system 140. The web address may be a uniform resource locator (URL). The web address may be associated with an interface. That is, the web address may be an address for a web server that serves the interface to a device that has activated the link.

In some embodiments where the first software application is a client application, activation of the selectable element 702 may cause the client device to launch a web browser application, pass the link to the web browser application and/or cause the web browser application to send the data access request to the authentication system.

The data access request may represent a request category, such as, for example, a data sharing request or a pay-by-bank request. A data sharing request may be for obtaining or retrieving data from the authentication system. A pay-by-bank request may be for configuring a payment in an e-commerce checkout. A pay-by-bank request may allow a customer to move money directly from a customer's account to a merchant's account. For example, a merchant may add a pay-by-bank option to their e-commerce checkout. When this option is selected by a customer, the customer may select a financial institution from a list. After selecting a particular financial institution, the customer may authenticate with their financial institution using a financial institution website or app for the selected financial institution. After authentication is complete, funds may be transferred directly from the customer's account to the merchant account and the checkout may proceed to completion.

In some embodiments, a data sharing request may be or include a request to perform a read-only operation in relation to a profile and/or account, and a pay-by-bank request may be or include a request to perform a modification operation in relation to an account.

In operation 404, the authentication receives, from the first system and by an authentication system, the first request. The first request may be received during an authenticated session associated with the first software application. For example, the first software application may be for an online e-commerce store and the customer may be logged into the store and thereby an authenticated browser session may have been established between a web browser and the first software application at the time that the authentication module receives the first request.

The request may include one or more parameters. For example, any one or a combination of an identifier identifying the first software application and/or an identifier of a server or system corresponding to or providing the first software application may be encoded as parameters in the request.

In operation 406, in response to receiving the data access request and indication of activation of the link, the authentication system may execute an authentication module.

Execution of the authentication module may initiate an authentication or data sharing flow. An authentication flow may include a series or sequence of interactive graphical user interfaces (GUIs) that are provided to the client device by the authentication system for configuring access, by the first system and/or the first software application, to data stored on the authentication system.

In addition to receiving the request, the authentication system may establish an unauthenticated browsing session between the authentication system and the client device. The browsing session may begin when the authentication system receives the request from the client device. For example, when a user of the client device visits a website hosted on the authentication system by activating the link, a browser application on the client device may transmit a Hypertext Transfer Protocol (HTTP) request to retrieve a webpage for the website. Upon receiving the request, the authentication system may generate a unique session identifier and send back the requested webpage along with the session identifier.

Operations 408, 410 and 412 that relate to a second system and second software application and may be similar to operations 402, 404 and 406 that relate to the first system and first software application.

In operation 408, the second system provides a second graphical interface for triggering a second data access request representing a second data access request category. The interface is provided by and corresponds to a second software application associated with the client device.

The provision of the second graphical interface by the second system may generally be similar to the provision of the first graphical interface by the first system. In some embodiments, the first and second systems may be the same client device. In some embodiments, the first and second systems may be separate systems. The first and second software applications may be different software applications. The first and second data access request categories may be the same or different. For example, the first request may represent a data sharing request and the second request may represent a request for configuring a payment in an e-commerce checkout. In some embodiments, the first and second request categories are different payment initiation protocols.

In operation 410, the second system receives a second request triggered by the second software application. The request may include one or more parameters. For example, any one or a combination of an identifier identifying the second software application and/or an identifier of a server or system corresponding to or providing the second software application may be encoded as parameters in the request.

In operation 412, in response to receipt of the second request by the authentication system, the authentication module is executed a second time. That is, the same authentication module may be used to service two different request categories from respective third-party systems. However, execution of the authentication module may vary based on the request category, the application or system the triggered the request, and/or the identifier that is included in the request received from the first and second systems, respectively.

In this way, an application-agnostic authentication flow may be provided at a financial institution system from the perspective of the customer. The same authentication module may be used to authenticate customers who wish to share financial institution data with third-party systems and customers who wish to use a value-added payment processing tool such as pay-by-bank.

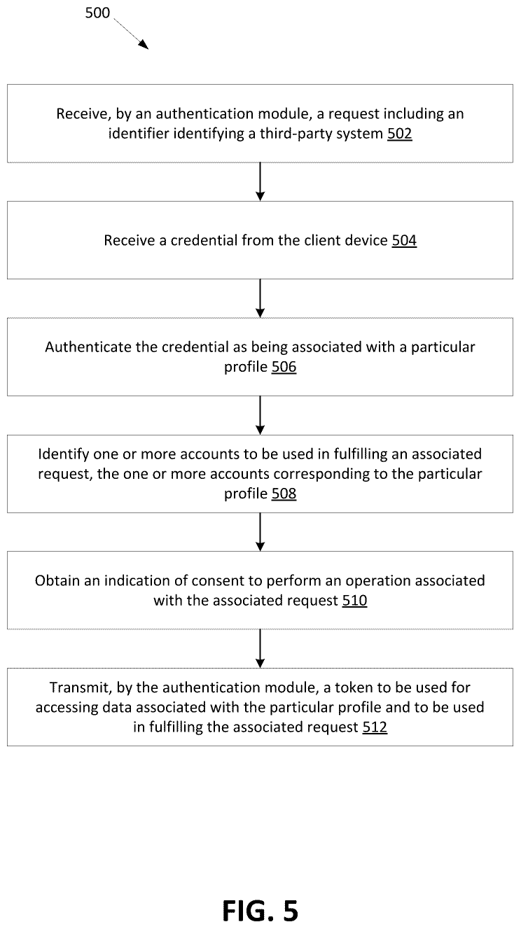

Reference will now be made to FIG. 5 which illustrates an example method 500 for executing an authentication module. The operations of the example method 500 may be performed by a computer system which may be of the type described herein. In some embodiments, the operations may be performed by the authentication system 140 of FIG. 1. The computer system performing these operations may interact with a client device 110 of FIG. 1, which may be referred to as a client system. It will be appreciated that one or more operations of the method 500 may correspond to or implement one or more operations of the method 400 of FIG. 4. The one or more operations of the method 500 of FIG. 5 may be performed in response to an authorization system receiving a request from the first or second systems in the method 400 of FIG. 4.

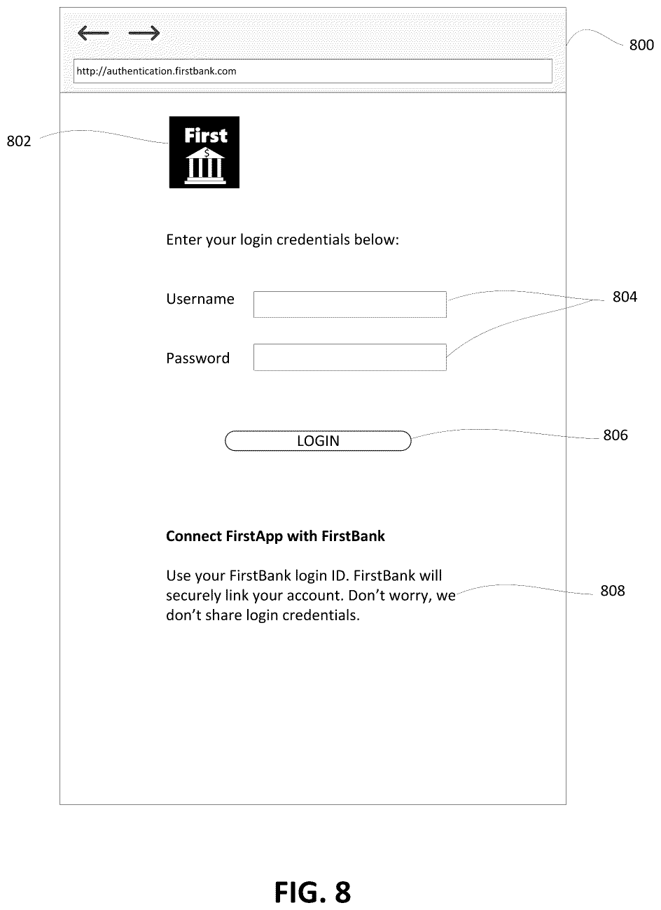

The authentication module may be configured to provide one or more interfaces for obtaining data from a client system. The one or more interfaces may include the interfaces 800, 900, 1000, 1100, 1200 and 1400 of FIGS. 8-12 and 14 and may be included in a flow referred to as an authentication or data access flow.

In operation 502, the authentication module receives a request. The request may correspond to the first or second request received by the authentication system in the method 400 of FIG. 4. The request may include an identifier that may be a request parameter and may correspond to or identify a software application or computer system that triggered the request, and/or an entity associated with or corresponding to the request, software application and/or computer system.

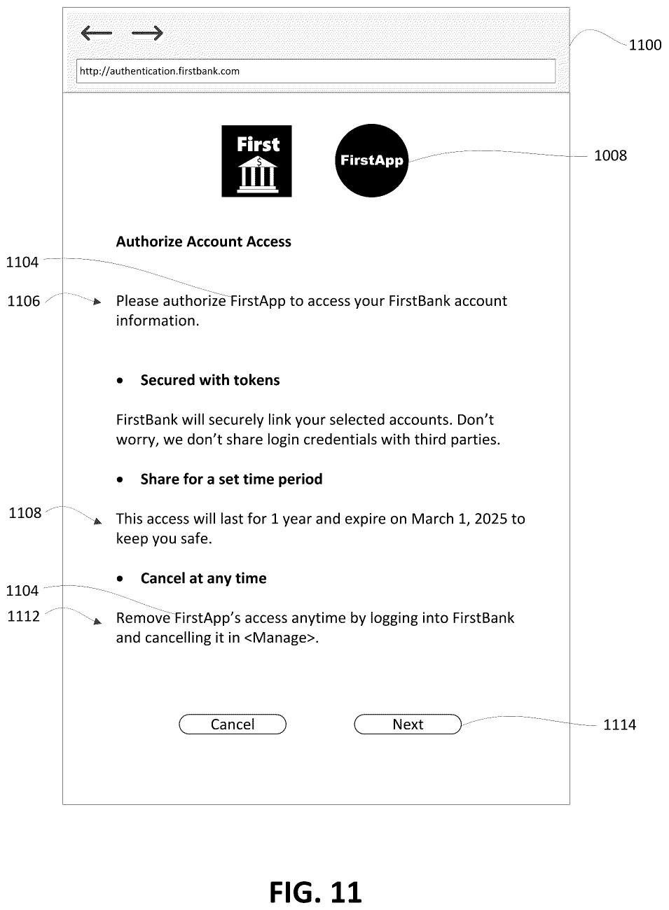

The authentication system may include a lookup table that maps the identifier to data to be used in the authentication flow. For example, the authentication module may map the identifier to branding associated with the identified software application. The lookup table may map the identifier to text representing the name of the software application or to a file representing an icon or logo corresponding to the software application. The data that is looked up may be used in one or more graphical elements of a graphical interface provided by the authentication system. For example, referring briefly to FIG. 11, the mapped logo and text may be used as the graphical element 1008 and the text element 1104 in the example authorization interface 1100, respectively. In some embodiments, the lookup table may also map the identifier to an expiry time period and/or terms and conditions such as a category of access, for example, data sharing, pay-by-bank, read-only, and/or modify data. In this way, the authentication flow may be tailored to the particular third-party software application and system that is seeking authorization.

In some embodiments, the request may directly include one or more parameters that provide some or all of the aforementioned data that may be stored in the lookup table. For example, the request may include parameters indicating the name of the software application and/or computer system seeking access, a parameter indicating an online location of an icon or logo file corresponding to the software application and/or computer system, an expiry time period, and/or a category of access that is being sought.

An execution of the authentication module results in an instance of the authentication flow. Accordingly, a first instance of an authentication flow may be different from a second instance of the authentication flow based on the software application/system that is seeking authorization, and a first instance of graphical interfaces included in the first instance of the authorization flow may differ from a second instance of graphical interfaces included in the second instance of the authorization flow. In this way, the authorization module may configure a first instance of a graphical interface to include one or more elements with a first software application and a second instance of the graphical interface to include one or more interface elements associated with the second software application instead of the one or more interface elements associated with the first software application. For example, a first instance of the example authorization interface 1100 may include the “FirstApp” logo corresponding to a first software application in the location of graphical element 1008, whereas a second instance of the authorization interface 1100 may instead include a different logo corresponding to a second software application.

Referring back to FIG. 5, in response to receiving a request in operation 502, the authentication system may provide, to a client device, an authentication interface for authenticating a user of the client device. Referring briefly to FIG. 8, shown is an example authentication interface 800 for authenticating a user of the client device. The authentication interface 800 may be displayed at the client device in a web browser upon receipt of the request. The authentication interface 800 includes a graphical element 802 corresponding to the authentication system and representing branding corresponding to the authentication module and/or system. The graphical element 802 may be included in one or more or all graphical interfaces included in the authentication flow. The graphical element 802 may be, for example, an icon or logo. The authentication interface 800 includes input areas 804 to receive data indicating a username and password. The authentication interface 800 also includes a selectable element 806 for submitting the credentials to the authentication system. The authentication interface 800 also includes a text message 808 indicating that the credentials will not be shared, for example, with a third-party entity, software application, and/or system.

Referring back to the method 500 of FIG. 5, in operation 504, the authentication module receives the credentials from the client device.

In operation 506, in response to receiving a credential, the authentication module authenticates the credential as being associated with a particular profile. For example, the authentication module may identify the particular profile based on an identifier, for example a username, included in the credentials and verify that a password included in the credentials corresponds to a password included in the particular profile.

Upon authentication of the user of the client device, the computing system may provide a terms and conditions interface for obtaining input from the user indicating acceptance of the terms and conditions included in the interface.

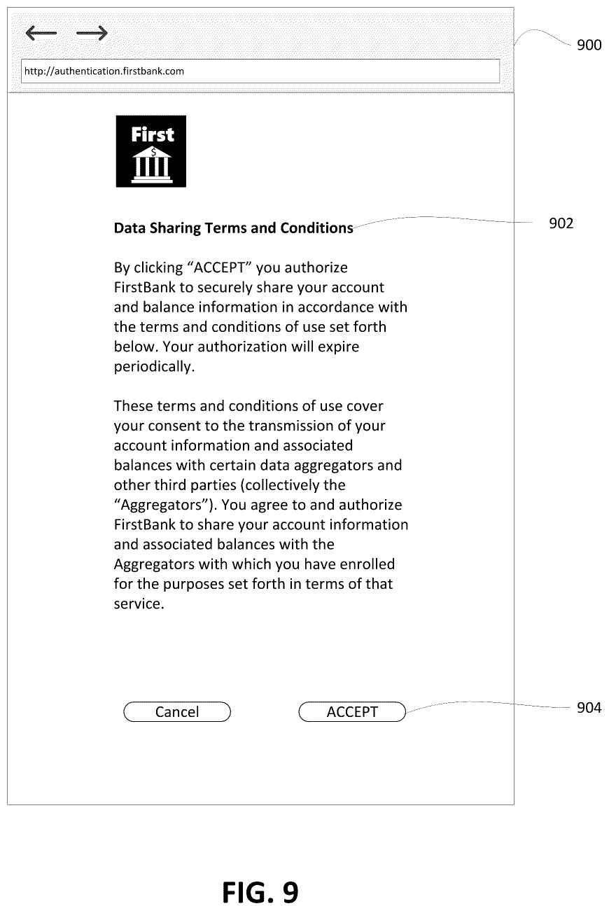

Referring briefly to FIG. 9, an example terms and conditions interface 900 is illustrated. The terms and conditions interface 900 may be displayed at the client device in a web browser upon authentication of the user of the client device. The terms and conditions interface 900 includes terms and conditions 902 for an entity, system and/or software application to access data and/or for the authentication system to share data. The terms and conditions interface prompts the user to provide their acceptance and includes a selectable option 904 that may be activated to trigger the client device to transmit to the computing system user input indicating that the user accepts the terms and conditions.

Referring back to FIG. 5, in response to receiving the user input indicating acceptance, in operation 508, the authentication system may automatically identify one or more accounts to be used in fulfilling an associated request. The one or more accounts should correspond to the particular profile associated with the received credential.

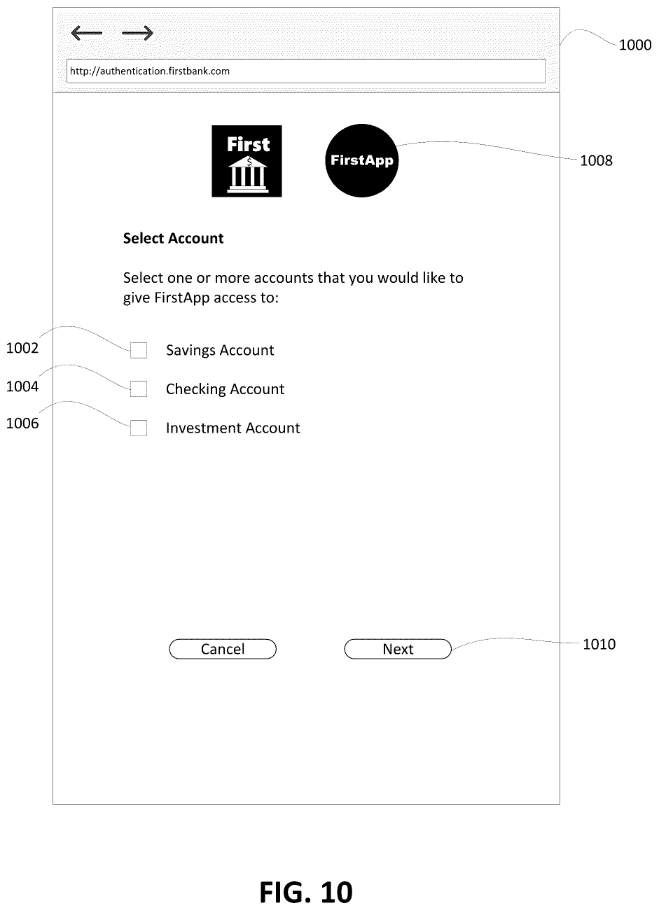

The authentication system may provide, to the client device, an account identification interface for prompting for identification of one or more accounts to be used in fulfilling the associated request. Referring briefly to FIG. 10, shown is an example account identification interface 1000 for identifying one or more accounts. In some embodiments, the user interface may provide one or more user selectable options for selecting one or more accounts of a plurality of accounts included in the particular profile. The example account identification interface 1000 includes a first option 1002 for identifying a savings account, a second option 1004 for identifying a checking account, and a third option 1006 for identifying an investment account. The first, second and/or third options may be presented as a link, button or other actionable user interface element and may include text.

The account identification interface 1000 also includes a graphical element 1008 corresponding to the third-party entity, software application and/or system and representing branding corresponding to the third-party entity, software application and/or system. The graphical element 1008 may be included in one or more or all graphical interfaces included in the authentication flow. The graphical element 1008 may be, for example, an icon or logo.

The interface 1000 also includes a selectable element 1010 that may be activated to trigger the client device to submit to the authentication module an indication of the identified accounts to the authentication system.

Referring back to FIG. 5, in operation 510, the authentication system may obtain an indication of consent to perform an operation associated with the associated request. To obtain the indication of consent, the authentication system may provide an authorization interface for obtaining authorization to access profile information regarding the particular profile, which may include account information regarding the one or more identified accounts.

Referring briefly to FIG. 11, an example authorization interface 1100 is illustrated. The example authorization interface 1100 prompts the user to provide their consent and includes a selectable element 1114 that may be activated to trigger the client device to transmit to the authorization system an indication that the user consents. The authorization interface 1100 may also include a message 1106 requesting a user to select the selectable element 1114 to authorize access to the one or more identified accounts. The authorization interface 1100 may also include instructions 1112 for canceling such authorization.

The example authorization interface 1100 includes the graphical element 1008 included in the account identification interface 1000 of FIG. 10. The authorization interface 1100 also includes a text element 1104 corresponding to the graphical element 1008 and/or identifying or corresponding to a third-party entity, software application and/or system that triggered the request in operation 502 and may represent branding corresponding to the third-party entity, software application and/or system. The text element 1104 may be included in one or more or all graphical interfaces included in the authentication flow. The text element 1104 may be included within one or more other text elements, such as, for example, the message 1106 and instructions 1112.

The authorization interface 1100 may also include an expiry message 1108 indicating when the authorization will expire and no longer be valid.

Referring back to FIG. 5, in operation 512, in response to receiving the indication of authorization, the authentication module may automatically issue and transmit an access token to be used for accessing data associated with or corresponding to the particular profile and/or the one or more identified accounts. The token may, for example, be an OAuth (“Open Authorization”) token or a variation thereof.

The authentication module may also automatically generate and transmit a notification based on the indication of authorization.

The token and/or notification may be transmitted to one or more of the client device, a system and/or software application that initiated the authentication flow, and a system and/or software application that has now been authorization to access to the identified accounts. The notification may be provided as a notification interface.

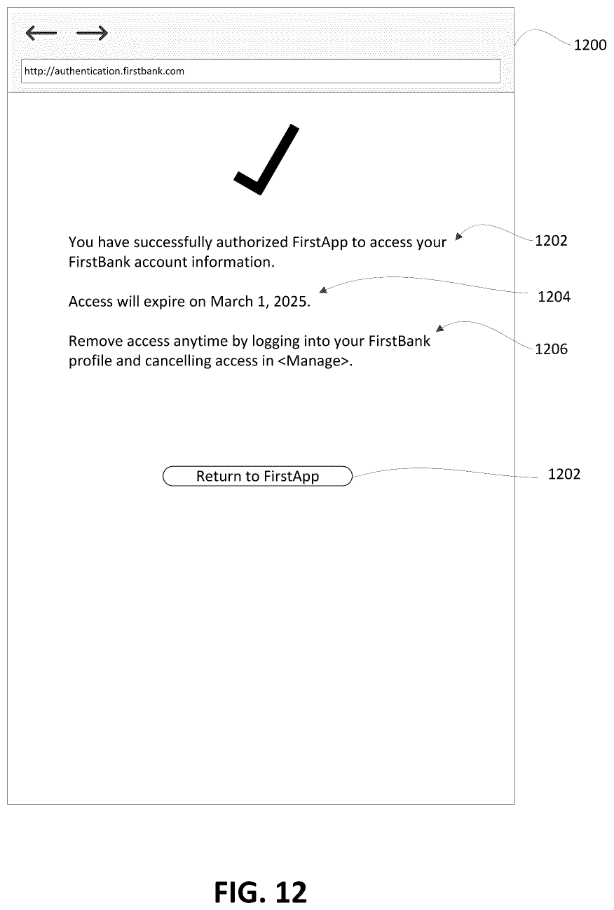

Referring briefly to FIG. 12, an example notification interface 1200 is illustrated. The notification interface 1200 may include one or more messages. For example, the notification interface 1200 may include a success message 1202 indicating that authorization has been successfully authorized for the one or more identified accounts. Another message may be an expiry date message 1204 for the authorization. Yet another message may be an instruction message 1206 indicating steps a user may take to revoke their authorization and cancel access to the one or more identified accounts.

The example notification interface 1200 may include a selectable element 1208 that may be actuated to trigger the client device to cause a browser application displaying the notification interface to redirect to a software application that initiated the authentication flow and/or now has access to the identified accounts. The redirection may cause the browser application to display a success interface. The success interface may be provided to the client system by a software application external to the authentication module and authentication system. In some embodiments, the success interface is provided by the software application or system that triggered the request in the operation 502 of the method 500 of FIG. 5, which may be a third-party software application or system.

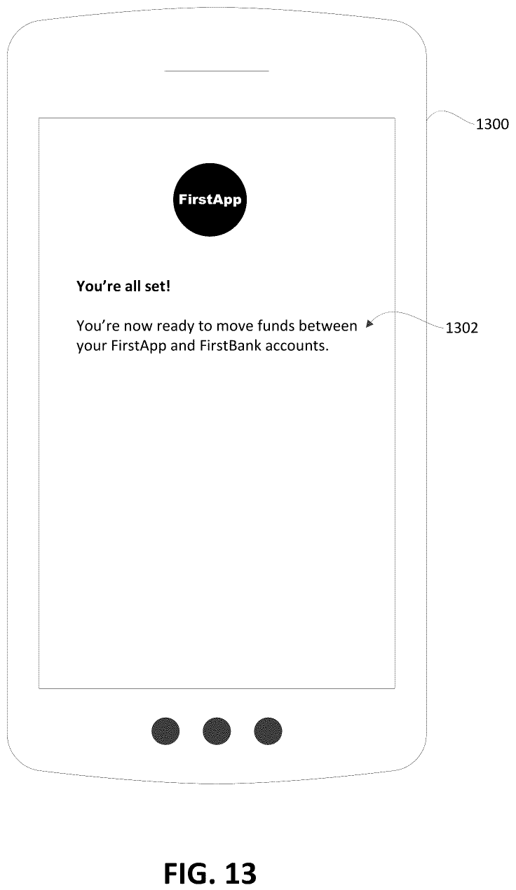

Referring briefly to FIG. 13, an example success interface 1300 is illustrated. The success interface 1300 may include a message 1302 indicating one or more operations that are authorized based on the authentication flow.

Upon receiving the token from the authentication module, the token may be used by the recipient software application and/or system, or corresponding third-party system, to fulfill the associated request and access data stored by the authentication system. By way of example, the associated request may be, for example, to share details of the particular profile with the requesting system. In some embodiments, the authentication system may use the identified one or more accounts to fulfill the associate request. For example, the associated request may be to transfer resources from one of the identified accounts to the requesting system. In this way, for example, a pay-by-bank transfer may be completed.

By using the same authentication module for various use cases, the authentication system realizes an efficiency improvement over existing systems. Additionally, customers may have an improved experience since the authentication flow will be familiar in various contexts.

The same authentication module may be executed to provide access to data or payments. In both contexts, the same module may be used to authenticate a user as being associated with a particular profile. The same module may also be used to provide consent and account identification.

The authentication module described herein may be used in other systems apart from systems that regularly pull financial institution data, such as personal financial management systems, and payment systems. For example, in some instances, the authentication module may be used by third-party systems that request customer data for identification, for example, to login to another website. In another example, the same authentication module may be used for the secure and safe storage of documents received from third-party systems.

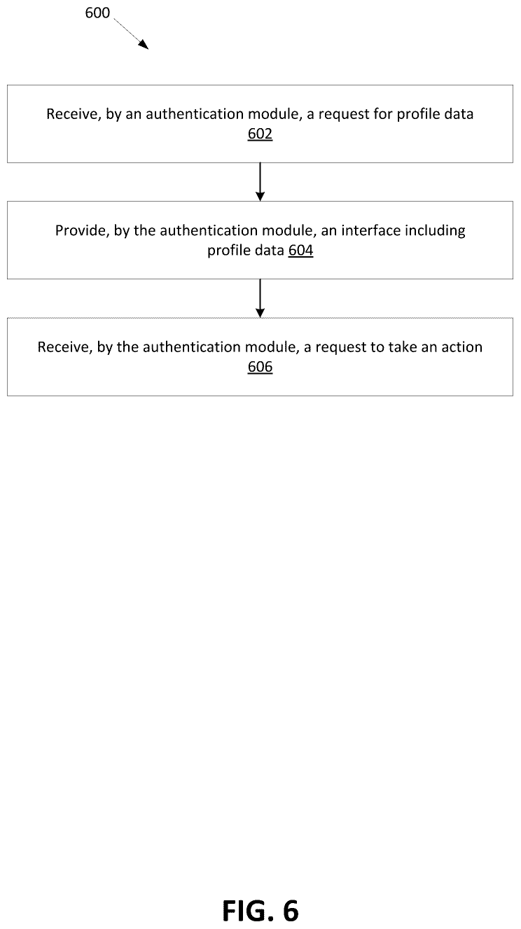

Reference will now be made to FIG. 6 which illustrates another example method 600 for executing an authentication module. The operations of the example method 600 may be performed by a computer system which may be of the type described herein. In some embodiments, the operations may be performed by the authentication system 140 of FIG. 1. The computer system performing these operations may interact with a client device 110 of FIG. 1, which may be referred to as a client system. It will be appreciated that one or more operations of the method 600 may be correspond to or implement one or more operations of the methods 400 and 500 of FIGS. 4 and 5. The one or more operations of the method 600 of FIG. 6 may be performed in response to an authorization system receiving a request from the first or second systems in the method 400 of FIG. 4 and/or during an execution of the authentication module in the methods 400 and 500 of FIGS. 4 and 5.

In operation 602, an authentication module receives a request for profile data and/or for managing profile data. The request may be received from a client device. The request for profile data may be or include a request for one or more preferences corresponding to a particular profile, and/or a request for managing data sharing and access permissions corresponding to a particular profile. The particular profile may be the one referred to in the method 500 of FIG. 5. In some embodiments, the request is triggered by actuation of the selectable element 1010 included in the account identification interface 1000 of FIG. 10 and the request may be a request for the authentication module to provide an interface for setting one of the one or more identified accounts as a default account.

In operation 604, in response to the request, the authentication module may provide to the client device a profile management interface including the requested profile data. The interface may include one or more graphical elements for managing data sharing and access permissions and/or preferences for the particular profile. The one or more preferences may include details of default account settings. A default account may, for example, be an account that is used by default by an authorization system in fulfilling a request from a third-party software application or system that has been authorized to access one or more accounts.

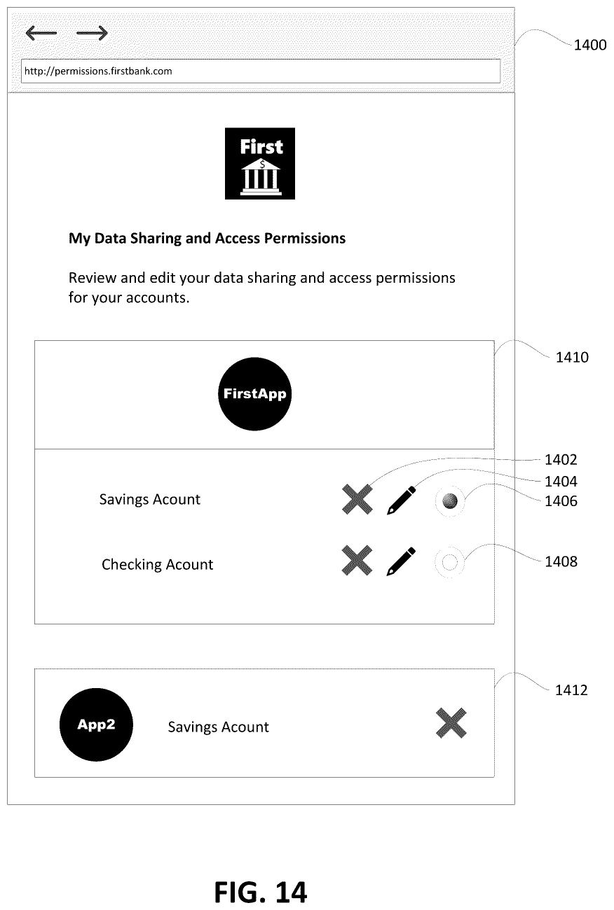

Referring briefly to FIG. 14, an example profile management interface 1400 is illustrated. The example profile management interface 1400 indicates that two applications, namely “FirstApp” and “App2” have been authorized to access accounts maintained by “FirstBank”. The “FirstApp” application authorization to access savings and checking accounts, and the “App2” application has authorization to access only the savings account.

The example profile management interface 1400 includes a first and second set of graphical elements 1410 and 1412 corresponding to a first and second application, respectively. Each set of graphical elements may be for managing data sharing and access permissions and/or preferences corresponding to a particular third-party application, entity and/or system and one or more identified accounts. The first set of graphical elements 1410 includes a cancel element 1402, an edit element 1404, a default account element 1406, and a non-default account element 1408.

The cancel element 1402 may be actuated to cancel authorization and/or revoke a token corresponding to a first account, for example, a savings account. In some embodiments, the cancel element 1402 may be actuated to cancel authorization and/or revoke a token corresponding to the one or more identified accounts. In some embodiments, the cancel element 1402 may be actuated to cancel authorization and/or revoke a token in relation to a third-party application or system.

The edit element 1404 may be actuated to edit one or more data sharing and access permissions associated with the first account. For example, the edit element may be selected to edit an expiry date for the authorized access.

The default account element 1406 may be a status indicator and indicate that the corresponding account (i.e. the savings account in this example interface) is the default account for data sharing and access operations performed by the first third-party application “FirstApp”.

The non-default account element 1408 is a status indicator and indicate that the corresponding account (i.e. the checking account in this example interface) is not a default account. The non-default account element 1408 may be actuated to set the checking account to be the default account instead of the savings account. Upon actuation, the non-default account element 1408 may transition to a default account icon and the default account element 1406 may transition to a non-default account icon.

In some embodiments, the example profile management interface 1400 is varied such that a default account may be specified or modified at the profile scope and the default account may, in that scenario, apply to all third-party applications that have been granted authorization to access any account included in the particular profile.

In operation 606, the authentication may receive, via the provided interface, a request to take an action. The request may be triggered by actuation of an interface element included in the profile management interface 1400. In some embodiments, the request may include an indication to cancel authorization, revoke a token, modify one or more preferences, set an account as a default account, modify a default account and/or take any other action. The authentication module may, in real-time, take the action that is requested.

In some embodiments, the authentication module may be configured with preferences for a customer that may be applied whenever the authentication module is engaged for that customer. For example, a customer may set a default account that may be used for all uses of the authentication module. Other preferences may be set in other implementations. In some implementations, one or more of the preferences may be shared with third-party systems. This may facilitate third-party systems to issue requests to the authentication module to update the preferences. Updating of those preferences may be performed using the same authentication module that is used for other operations, as described above.

By using the same authentication module for various contexts, other advantages may be realized. For example, a common consent hub may list all third-party applications and/or systems for which sharing, payments, and/or other functions that use the authentication module have been enabled.

In some embodiments, the authentication system may monitor or track the usage of the authorization module and provide a historical list that defines, in one common place, any third-party entities, systems and/or applications that have engaged the authorization module and/or that have received access or data or functions through authorization via the authorization module.

It will be appreciated that the techniques described herein may be used in numerous scenarios. For example, such techniques may be used with account funding, which occurs when a customer is transferring a portion of an account balance from one institution to another. The computing system may, for example, use open banking techniques to share account information for an account from which a transfer is to be made. By way of further example, such techniques may be used in a where funds are transferred from a bank account to an investment portfolio account on an investment platform.

In another example, the techniques described herein may be used in a financial advisor scenario. In such a scenario, the shared data may be analyzed by a third-party system so that the advisor may provide appropriate advice based on the analysis. For example, it may be that the third-party system may in real-time evaluate a customer's spending so that the advisor may make a recommendation, or it may be that the third-party system may in real-time evaluate the customer's investment portfolio so that the advisor may make an appropriate recommendation.

Further, it will be appreciated that data may be obtained by other third-party systems apart from financial institution systems using the open banking techniques or, more generally, open finance techniques described above.

It will be appreciated that it may be that some or all of the above-described operations of the various above-described example methods may be performed in orders other than those illustrated and/or may be performed concurrently without varying the overall operation of those methods.

It will also be appreciated that some or all of the above-described operations of the various above-described example methods may be triggered by, or caused by, or performed in response to, one or more of the above-described operations, and may be performed in real-time or near real-time in response to one or more of the above-described operations and/or automatically without user input.

Some of the embodiments described herein focus on financial systems. However, it is understood that the present application is not limited to any such embodiments and that the embodiments described with respect to a particular type of transfer generally may be extended to other types of systems.

Although many of the above examples refer to an “object” when discussing a data structure, it will be appreciated that this does not necessarily restrict the present application to implementation using object-oriented programming languages, and does not necessarily imply that the data structure is of a particular type or format. Data structures may have different names in different software paradigms.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
a communications module;
one or more processors coupled to the communications module; and
a memory coupled to the one or more processors and storing instructions that, when executed by the computer system, cause the computer system to:
receive a first request from a first system executing a first software application, the first request triggered by the first software application and representing a data sharing request;
in response to receiving the first request, execute an authentication module;
receive a second request from a second system executing a second software application, the second request triggered by the second software application and representing a request for configuring a payment in an e-commerce checkout; and
in response to receiving the second request, execute the authentication module, wherein executing the authentication module configures the authentication module to:
authenticate a credential received from the second system as being associated with a particular profile;
identify one or more accounts to be used in fulfilling an associated request, the one or more accounts corresponding to the particular profile; and
obtain an indication of consent to perform an operation associated with the associated request.

2. The computer system of claim 1, wherein the first and second software applications are third-party applications, the authentication module is included in a web application that is separate from the first and second software applications, and the first and second systems are client devices.

3. The computer system of claim 1, wherein the request for configuring the payment in the e-commerce checkout is a pay-by-bank request and the one or more accounts are one or more bank accounts.

4. The computer system of claim 1, wherein the instructions cause the computer system to receive the second request triggered by the second software application and execute the authentication module in response to receiving the second request during an authenticated session associated with the second software application.

5. The computer system of claim 1, wherein the second request includes an identifier associated with the second software application.

6. The computer system of claim 5, wherein the instructions cause the computer system to execute the authentication module in response to receiving the second request further cause the computer system to map the identifier to data to be used in one or more graphical elements of a graphical interface.

7. The computer system of claim 6, wherein the instructions cause the computer system to execute the authentication module in response to receiving the first request further cause the computer system to configure a first instance of the graphical interface to include one or more interface elements associated with the first software application.

8. The computer system of claim 7, wherein the instructions cause the computer system to execute the authentication module in response to receiving the second request further cause the computer system to configure a second instance of the graphical interface to include one or more interface elements associated with the second software application instead of the one or more interface elements associated with the first software application.

9. The computer system of claim 7, wherein the one or more interface elements associated with the first software application include a representation of branding associated with the first software application.

10. The computer system of claim 1, wherein the instructions further cause the computer system to provide a historical list defining entities corresponding to a plurality of software applications, including the first and second software applications, that have engaged the authentication module.

11. A computer-implemented method comprising:
receiving a first request from a first system executing a first software application, the first request triggered by the first software application and representing a data sharing request;
in response to receiving the first request, executing an authentication module;
receiving a second request from a second system executing a second software application, the second request triggered by the second software application and representing a request for configuring a payment in an e-commerce checkout; and
in response to receiving the second request, executing the authentication module, wherein executing the authentication module configures the authentication module to:
authenticate a credential received from the second system as being associated with a particular profile;
identify one or more accounts to be used in fulfilling an associated request, the one or more accounts corresponding to the particular profile; and
obtain an indication of consent to perform an operation associated with the associated request.

12. The method of claim 11, wherein the first and second software applications are third-party applications, the authentication module is included in a web application that is separate from the first and second software applications, and the first and second systems are client devices.

13. The method of claim 11, wherein the request for configuring the payment in the e-commerce checkout is a pay-by-bank request and the one or more accounts are one or more bank accounts.

14. The method of claim 11, wherein receiving the second request triggered by the second software application and executing the authentication module in response to receiving the second request occur during an authenticated session associated with the second software application.

15. The method of claim 11, wherein the second request includes an identifier associated with the second software application.

16. The method of claim 15, wherein executing the authentication module in response to receiving the second request includes mapping the identifier to data to be used in one or more graphical elements of a graphical interface.

17. The method of claim 16, wherein executing the authentication module in response to receiving the first request includes configuring a first instance of the graphical interface to include one or more interface elements associated with the first software application.

18. The method of claim 17, wherein executing the authentication module in response to receiving the second request includes configuring a second instance of the graphical interface to include one or more interface elements associated with the second software application instead of the one or more interface elements associated with the first software application.

19. The method of claim 17, wherein the one or more interface elements associated with the first software application include a representation of branding associated with the first software application.

20. A non-transitory computer-readable storage medium comprising processor-executable instructions which, when executed, configure one or more processors to:
receive a first request from a first system executing a first software application, the first request triggered by the first software application and representing a data sharing request;
in response to receiving the first request, execute an authentication module;
receive a second request from a second system executing a second software application, the second request triggered by the second software application and representing a request for configuring a payment in an e-commerce checkout; and
in response to receiving the second request, executing the authentication module, wherein executing the authentication module configures the authentication module to:
authenticate a credential received from the second system as being associated with a particular profile;
identify one or more accounts to be used in fulfilling an associated request, the one or more accounts corresponding to the particular profile; and
obtain an indication of consent to perform an operation associated with the associated request.
